(19) United States
(12) Patent Application Publication
(10) Pub. No.: US 2005/0266306 A1
(43) Pub. Date: Dec. 1, 2005

(54) Multiple contact collectors

(75) Inventors: Jon K. West, Gainesville, FL (US); Thomas J. McCall, Ft. White, FL (US); Thomas E. Audit, Alachua, FL (US)

Correspondence Address: MORRISON & FOERSTER LLP, 1650 TYSONS BOULEVARD, SUITE 300, MCLEAN, VA, 22102, US

(73) Assignee: WAVECREST LABORATORIES, Dulles, VA (US)

(21) Appl. No.: 10/853,765

(22) Filed: May 26, 2004

(51) Int. Cl. H01M 2/26; H01M 4/64

(52) U.S. Cl. 429/161; 429/233; 429/94; 29/623.1

(57) ABSTRACT

Disclosed is a multiple-contact current collector for use in energy storage cells. The current collector of the present invention provides for lower internal resistance and higher conductivity than previous current collectors, thereby achieving increased current handling capacity, improved heat rejection, and lower discharge temperatures. The collector is characterized by a series of protrusions arranged around the perimeter of the plate that connect to the positive windings of the cell and are subsequently welded thereto. Additionally, the collector is provided with protrusions and dimples to increase the area of contact between the collector plate and the winding.

### FIELD OF THE INVENTION

The present invention relates to multiple contact current collectors for use in electrolytic energy storage devices that may comprise single or multi-cell batteries. Disclosed is a novel-multiple-contact collector and method for assembling an energy storage cell with such a collector that provides improved manufacturing to achieve higher current and power output at lower temperatures.

### BACKGROUND OF THE RELATED ARTS

Batteries of the type relevant to the present invention are conventionally constructed with a set of anode plates and a set of interleafing cathode plates, which may be spirally wound and spaced apart by separators infused with an electrolyte. The anode plates must be electrically connected to the battery anode terminal, and the cathode plates must be electrically connected to the battery cathode terminal. These portions of the energy storage cell comprise the positive and negative terminals of the cell. For the sake of rigidity of the assembled sets of anode and cathode plates, the connection between the plates and the terminals is typically mechanical as well as electrical, and is accomplished with current collectors that can take various forms.

The electromechanical attachment of the anode and cathode plates to their respective current collectors can be labor intensive and be a source of quality problems during battery construction. Ideally, the current assembly would rigidly support the plates to help prevent their deformation within the battery case and to resist vibrational damage to the plates and separators. Further, the current tab should be formed of a material that is readily connectable to both the terminal and to the plates in a manner that assures an easy and dependable electrical and mechanical attachment. It is particularly important that the electrical connection to both the plates and the collectors be of the lowest possible resistance, or at least of a resistance no greater than the resistance in the plates and terminals themselves, so that the impedance of the connection is minimized and the current capacity is maximized.

One desirable electrical characteristic of such batteries is a very high charge and discharge rate. A high charge and discharge rate requires high current carrying capacity in the electrical connection from the plates to the terminals, in order to both carry the load without reducing the charge and discharge rate and also to avoid resistive overheating that could structurally or electrically damage the battery.

The prior art discloses many types of end connectors that are designed to enhance the structural integrity or to minimize the electrical impedance of batteries. For example, U.S. Pat. No. 4,539,273 by Goebel describes a set of plates wound on a spool with an anode flange and a cathode flange. Each plate has a set of connecting tabs spaced along an edge, which is in electrical contact with the appropriate spool flange. The Goebel device does not provide for any secure mechanical connection between the spool flange and the plates. Also, the Goebel device would appear to require a fairly intricate manufacturing process, especially if used on a very thin plate battery having a very long plate edge that would require a large number of connecting tabs.

In U.S. Pat. No. 3,695,935 by Cromer, there is disclosed a spirally wound plate design where the anode plate is wound offset from the cathode plate so that the anode plate edge overhangs one edge of the spiral and the cathode plate edge overhangs the other edge of the spiral. The two overhanging edges are “ruffled”. The purpose of the ruffles is said to be to strengthen the edges against damage during manufacturing, to blunt the edges to reduce the potential for injuring manufacturing workmen, and to increase the conductivity between the plate and the terminal. The Cromer device uses an ordinary strap type end connector to join the plates to the terminal.

One of the more common arrangements for electrically connecting the plates to the terminals is shown in U.S. Pat. No. 3,862,861 by McClelland et al. In the structure shown by McClelland, the plates include spaced tabs on the plate edge so that the wound plate has a set of tabs protruding from an end. The protruding tabs are then joined together and connected to the current collector. The McClelland arrangement is difficult to construct, may allow for electrolyte leakage, and may not lend toward high conductivity.

A significant factor not accounted for in the prior art is the relationship between conductivity and the contact area between the positive electrode and the positive current collector. It would, therefore, be desirable to have a design for a positive current collector that provides multiple points of contact between the collector and electrode to maximize the conductivity of the connection between the current collection and electrode and to decrease the internal resistance of the contact area between the electrode and collector, further it is desirable to be able to create a current path between the collector and cover that further minimizes the internal resistance of an energy storage device.

Moreover, positive current collectors of the prior art generally comprise a circular hub having a plurality of weld points and a protruding tab for connection to the battery cover. During assembly, such a collector must be carefully aligned prior to being welded to the coil, so that the integrated tab can be attached to the cover and then folded in a manner that permits the cover to be placed on the can. The alignment process can be difficult and if not done correctly may inhibit a secure seal between the cover and can. It is therefore desirable to have a positive collector that does not require alignment during the battery assembly process. It is further desirable to provide a collector that does not require an integrated tab.

The protruding tab of prior art collectors, as shown in FIG. 1, generally includes a slit to create a sacrificial portion that is burned away during the welding process, to avoid creating a short circuit for the welding current. At the point where the tab meets the circular hub of the collector, however, it is possible for at least one, if not both, of the metal surfaces to burn away during the melding process or to lose structural integrity. If one of these portions breaks, which is often the case, the current carrying capacity of the battery is greatly reduced. If both break, the battery fails. If this occurs during the manufacturing process, it adds to the manufacturer's reject rate. It is therefore desirable to provide a system for creating a current path between the positive collector and battery cover that is not easily susceptible to failure.

By failing to provide for high conductivity at the current collectors, prior art devices can exhibit high effective resistance which, in turn, leads to higher heat discharge and lower efficiency.

It is also desirable to provide a current collector that has high conductivity with low resistance in a single cell energy source.

It is also desirable to provide a current collector that improves heat rejection during discharge of a single cell energy source.

As well, it is desirable to provide a current collector that facilitates alignment and orientation of single cell energy sources when processed or assembled into multi-cell batteries.

### SUMMARY OF THE INVENTION

The present invention relates to a current collector configured for establishing at least one current path with an electrode of an energy storage device. The energy storage device has multiple electrodes of opposite polarity, i.e. positive and negative, and may be wound in a cylindrical arrangement. While the current collector may have a radially symmetric configuration in this embodiment, it should be appreciated that the present invention may be employed in energy storage devices having a variety of different configurations including, for example, non-radial, non-cylindrical, prismatic and oval cells.

The current collector may have a radially symmetric configuration allowing for the creation of at least one current path between the current collector and the anode. The current path or paths can be established irrespective of orientation of the coil and the current collector relative to an axis common to the coil and the current collector. Alternatively, the current collector may have a radially asymmetric element configured for establishing at least one current path with the current collector.

The current path between the radially asymmetric element and the current collector may be established after one or more current paths between the current collector and an electrode of the energy storage device are established. Alternatively, the current path between the radially asymmetric element and the current collector may be established after the current collector and the anode are mutually positioned.

A plurality of surface variations in the current collector configured to enhance the current paths between the anode and/or cathode and the current collector may be machined or otherwise formed in or on the collector. Surface variations in the current collector are configured to increase the number of current paths between the anode and the current collector.

In one method of making an energy storage cell using the collectors described herein, the a radially symmetric current collector is positioned on an electrode of a coiled energy storage device along a common radial axis. Such a configuration may reduce effective electrical resistance of the coiled energy storage device by establishing at least one electrical current path between the current collector and the anode. The method may also include positioning a radially symmetric current collector and an anode, or other electrode, of a coiled energy storage device along a common radial axis, and improving energy cell heat rejection by establishing at least one electrical current path between the current collector and the anode. Alternatively, a radially symmetric current collector and an anode of a coiled energy storage device may be positioned along a common radial axis, thereby increasing energy cell current capacity by establishing at least one electrical current path between the current collector and the anode.

In an energy storage device which has a coil with an anode, a radially symmetric current collector may be configured to establish at least one electrical current path with the anode by positioning the electrode and collector along a common axis with the energy storage device. The energy storage device may be a coil when a coiled cell is to be produced. At least one electrical current path between the current collector and the anode is established irrespective of orientation of the coil, or energy storage device. Preferably, the coil may have an outer diameter and an inner diameter and the outer diameter and the inner diameter define a ratio of not less than 6 to 1.

The energy storage device may also be characterized as having surface variations in the current collector and/or on the anode spiral surface configured to increase the number of current paths between the anode and the current collector. Such an energy storage device may create at least two current paths between the electrode and the current collector.

An alternative method for creating a cell in accordance with the invention may be characterized by providing a coil including an anode. A radially symmetric current collector is used to establish at least one electrical current path with the anode. The coil and the current collector are position along an axis common to both elements. Thereby, at least one current path is established between the current collector and the anode. It may also be desirable to provide surface variations in the current collector to enhance the current paths between the anode and the current collector.

Devices made in the manner described herein may exhibit improved heat rejection, greater efficiency, lower operating temperatures, a lower effective internal resistance, and greater longevity.

### BRIEF DESCRIPTION OF THE DRAWING FIGURES

FIG. 1(a) illustrates an embodiment of a positive current collector according to the prior art having an integrated collector to cover tab.

FIG. 1(b) illustrates a current collector having an integrated collector to cover tab in a position wherein the cover and collector tab are in contact.

FIGS. 2(a)-(c) show detailed views of an embodiment of a cover to collector terminal according to the present invention, including exemplary weld projections.

FIGS. 3(a), 3(b), and 3(c) illustrate the tab, shown in detail in FIG. 3(c), to cover weld process in top plan and side plan view.

FIG. 4(a) shows a battery cover and collector to cover tab in a position suitable for welding to the collector.

FIG. 4(b) shows a multiple contact current collector adjacent to a cover to collector tab that has been bent.

FIG. 5 shows, in cross section, an embodiment of a battery according to the present invention.

FIG. 6 shows an example of an energy storage coil in top plan view.

FIGS. 7(a)-7(c) illustrate a multiple contact current collector having a plurality of weld projections that may be manufactured in a strip, as well as exemplary weld projections.

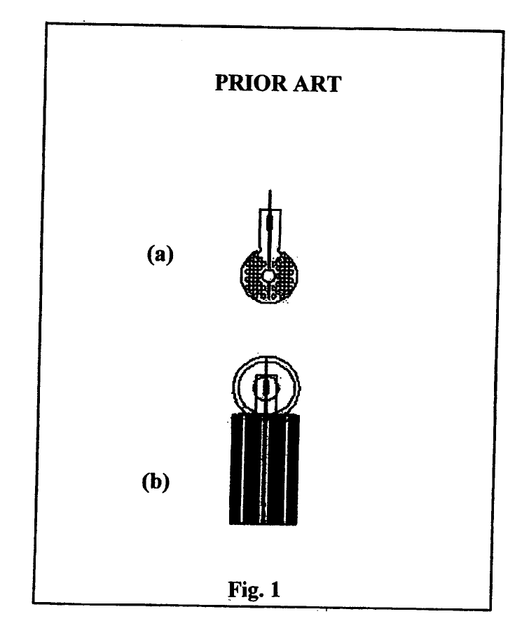

### DETAILED DESCRIPTION OF THE INVENTION

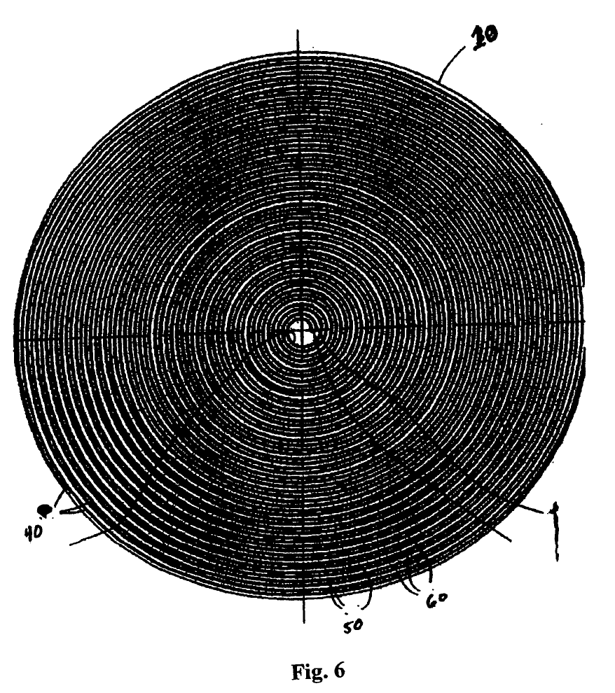

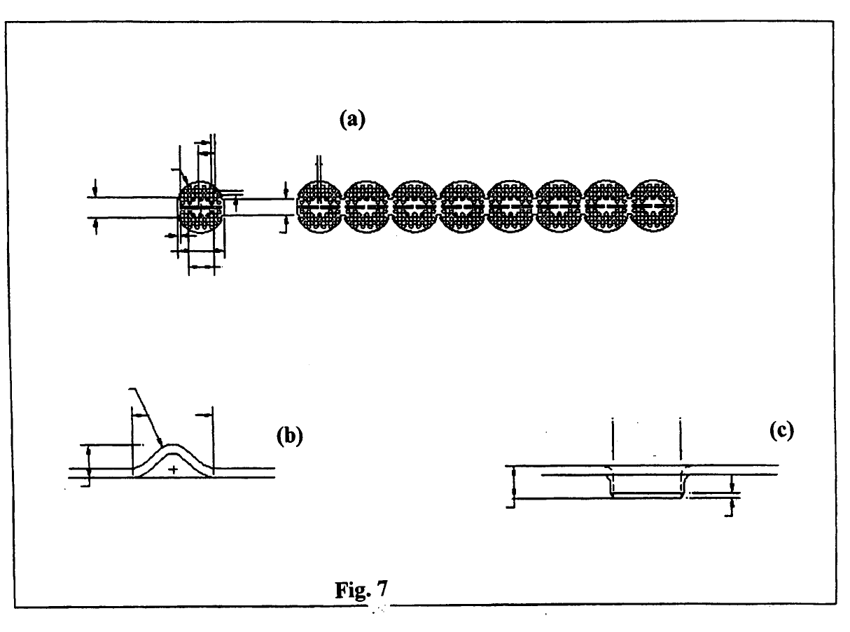

The present invention relates to an electrical energy storage device and, more specifically, to rechargeable storage cells such as D-Cell batteries. By way of example and illustration, the present specification describes D-Cell batteries. It is noted, however, that each of the principles and discoveries mentioned herein apply with equal weight to cells having a coiled energy storage device, such as AA, AAA, C, and other such cells, such as prismatic cells, for example, which do not employ coiled cores. Particularly, the present invention is a novel current collector and method for creating current paths between the positive collector and battery cover and for providing a low-resistance current path from the electrode coil to the cover. Although not limited to these advantages, the present invention overcomes the labor-intensive and failure-prone nature of prior art collectors, such as the collector shown in FIG. 6(a), and provides for a battery that emits less heat during charge and discharge by having a lower internal resistance than prior art batteries.

As illustrated by FIG. 6, an exemplary energy storage cell of the present invention includes a coiled energy storage device 10, a positive current collector 1, a positive current collector to cover tab 3, a negative current collector 2, and a conducting casing, or “can” 20. The can 20 is preferably chemically compatible with the electrochemistry of the storage device, and thus be substantially resistant and impermeable to the electrolyte used. Any such suitable material may be employed as the casing.

The electrical energy storage device, shown generally in FIG. 6 and noting that like parts are shown with corresponding reference numerals throughout the drawing figures, may comprise a coiled winding 10 having a cathode plate including a strip having a pair of elongated side edges, an anode plate including a strip having a pair of elongated side edges, and a separator located between the cathode and anode plates. Further, in an illustrative description of an energy storage device, it includes a coiled winding 10 made of three or more elongated rectangular strips wound together (depending on whether one or two separators are used): a cathode plate 40, an anode plate 50 and a separator 60. The separator 60 is wound between the cathode plate 40 and the anode plate 50 along their entire lengths to prevent the plates from contacting each other. The cathode plate 40 and the anode plate 50 each have two elongated side edges which extend along the entire lengths of the longest sides of the plates. Exemplary energy storage devices and methods which relate to the present invention are described in U.S. Pat. No. 6,265,098, U.S. Pat. No. 5,667,907, U.S. Pat. No. 5,439,488, and U.S. Pat. No. 5,370,711, each of which is hereby incorporated by reference in its entirety.

To provide a surface upon which each of the current collectors may be attached to the energy storage device, the cathode plate and the anode plate are wound in an offset relationship so that one elongated side edge of the cathode plate extends beyond one elongated side edge of the anode plate at a first side of the winding, and the other elongated side edge of the anode plate extends beyond the other elongated side edge of the cathode plate at a second side of the winding opposite the first side. The cathode plate and the anode plate are wound in an offset relationship so that the edge of the cathode plate extends beyond the edge of the anode plate at the circular first side of the winding. Similarly, at the circular second side of the winding, the other edge of the anode plate extends beyond the other edge of the cathode plate. Therefore, the edge of the cathode plate forms a spiral surface at the first side of the winding, and the edge of the anode plate forms a spiral surface at the second side of the winding.

Once the collectors are attached to the energy storage device and the device has been secured in the casing, an electrolyte material is introduced within the winding. A liquid electrolyte material is introduced between the plates in the winding and saturates the separator. If the plates are porous, the electrolyte material may also enter the pores to improve the output of the device. The electrolyte material can then be sealed within the casing to prevent leakage.

The electrolyte material allows the desired electrochemical reaction to occur within the winding. If the plates are made of nickel hydroxide and cadmium, the electrolyte material may comprise an aqueous alkaline solution such as potassium hydroxide. However, any suitable electrolyte which performs favorably in combination with the materials chosen as the plates may be used within the scope of the present invention.

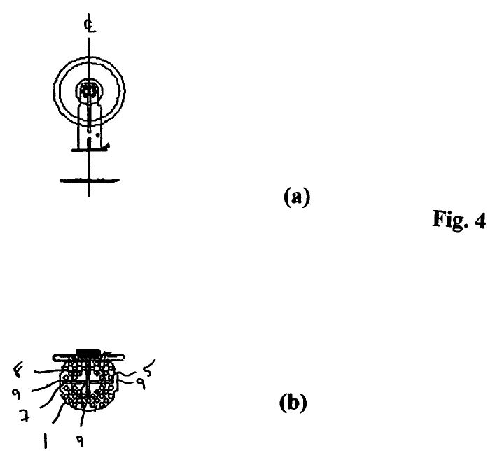

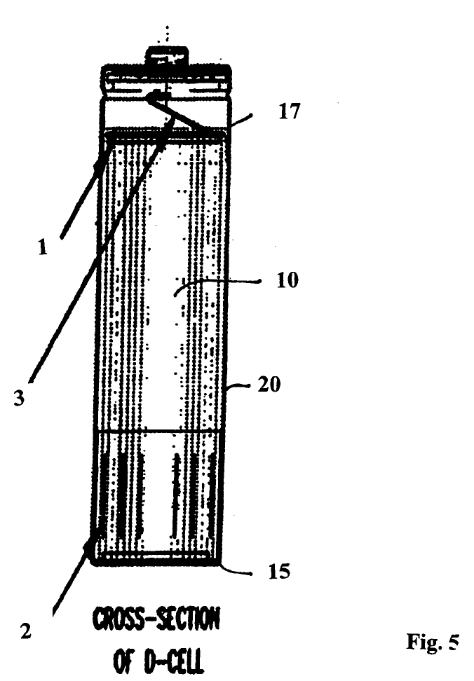

Two current collectors may be secured to the casing, one current collector being pressed against the first side of the winding to contact the cathode plate at a plurality of locations thereon, and the other current collector being pressed against the second side of the winding to contact the anode plate at a plurality of locations thereon. As illustratively embodied in FIG. 4, two current collectors 1 and 2 are pressed against the ends of the winding 10 to contact the respective plate edges. A negative current collector 2 is pressed against the first side 15 of the winding 10 to contact the cathode plate 40 and a positive current collector 1 is pressed against the second end 17 of the winding 10 to contact the anode plate 50. The offset relationship between the plates allows each current collector 1 and 2 to make direct electrical contact with a single plate without the need for tabs connecting the plates and collectors. However, in order to increase the current carrying capacity between the negative current collector and the cathode plate, it has been found to be advantageous to provide tabs that radially protrude from a central hub, or inner region of the collector, that can be folded to receive the cathode plate. Such a configuration is described in applicant's copending applications, serial numbers U.S. Ser. No. ______, U.S. Ser. No. ______, U.S. Ser. No. ______, and U.S. Ser. No. ______, which are hereby incorporated by reference in their entireties.

As shown in FIG. 4(b), the positive current collector may preferably comprise a plate having multiple protrusions arranged around its perimeter that are configured to abut the positive winding of the cell. These protrusions are subsequently welded to the positive winding via the plurality of weld projections provided thereon. A preferred positive current collector of the present invention also may include projections and dimples, collectively “surface variations”, to increase the conductive contact area between the collector and the winding, thereby lowering the internal resistance of the contact area between the winding and the collector and improving the heat rejection of the cell during discharge. The increased conductivity that results from the preferred collector permits for increased current capacity, as much as six times as much capacity with a similar temperature rise as that permitted by prior art positive current collectors.

Further, when a series weld is made, it is desirable that the current delivered by the welding apparatus does not short circuit through the article being welded. Accordingly, an illustrative current collector of the present invention, with reference to FIG. 4(b), may also include slots 7, or air gaps, where the current cannot flow. To hold the collector 2 together, small mechanical bridges 9 may be provided which are permitted to burn away during the welding process. After these bridges 9 have been sacrificed, there is no path through which the welding current may short circuit, forcing the current to travel through the central hub 8 of the collector, through the weld projections 5 and to the coil 10 (shown in FIG. 6). The current then travels back through the weld projections 5 into the other side of the collector. The weld projections 5 concentrate the current in the smallest physical area, creating a molten weld area.

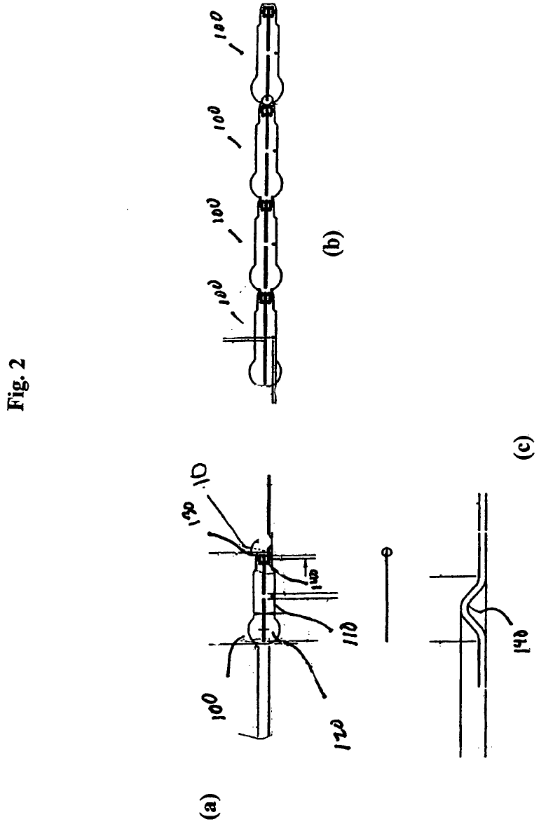

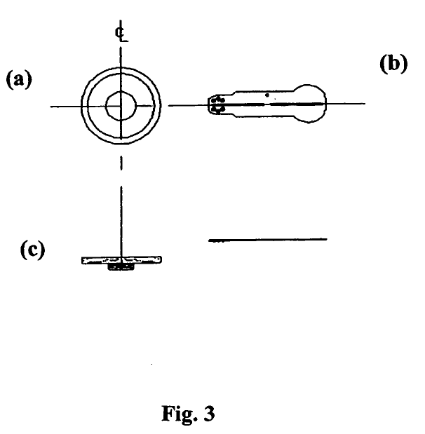

Since the positive collector of the present invention does not require an integrated tab, thereby reducing the need to align the position of the collector prior to creating the current paths between the collector and coil, a separate cover to collector tab may be provided. Such a tab is shown in FIGS. 4(a), 3(c), and, in greater detail FIG. 2(a). FIG. 4(a) illustrates one possible position of the cover to collector tab. As shown in FIG. 2(a), the cover to collector tab 100, in one illustrative embodiment, may be described as being an elongated metal strip 110 having a circular hub 120 for contacting a positive current collector and end portion 130 for contacting the inside of the battery cover. Both the hub 120 and end portion 130 may be provided with a plurality of weld projections 140 for forming mechanically strong connections between the tab and collector or tab and cover and for providing low resistance current paths between the collector, through the tab, to the cover. As well, the tab may be provided with a slit, or air gap, having sacrificial metal bridges that burn away during the welding process, to eliminating short circuiting of the weld current through the tab, thereby forcing the welding current through the weld projections when securing the hub 120 to the collector or end portion 130 to the cover. As well, since it is not necessary to secure the tab to the collector until after the collector has been secured to the coil, alignment procedures during the manufacturing process are eliminated and the cover may be secured to the tab and the tab folded to allow the cover to securely contact the casing.

An energy storage device in accordance with the present invention may be used for storing and supplying energy in a variety of different environments and for a variety of different purposes. For example, an energy storage device in accordance with the present invention may be used for storing and supplying energy in transportation vehicles, including for example ground transportation vehicles, air transportation vehicles, water surface transportation vehicles, underwater transportation vehicles, and other transportation vehicles. An energy storage device in accordance with the present invention may be used for storing and supplying energy in communication and entertainment devices, including for example telephones, radios, and televisions, and other communication and entertainment devices. An energy storage device in accordance with the present invention may be used for storing and supplying energy in home appliances as an alternative to AC current sources or in conjunction therewith. When used with an appropriate power inverter, energy storage devices of the present invention may also provide a substitute for AC current sources when such sources are unavailable or inconvenient. The examples described in this paragraph are merely representative, not definitive.”

1. A current collector, the current collector configured for establishing at least one current path with an electrode of an energy storage device, the energy storage device comprising at least a pair of electrodes having at least one separator therebetween, the current collector comprising a radially symmetric configuration, whereby at least one current path between the current collector and the electrode is established irrespective of orientation of the coil and the current collector relative to an axis common to the coil and the current collector.

2. The current collector of claim 1 comprising a radially asymmetric element configured for establishing at least one current path with the current collector, the at least one current path between the radially asymmetric element and the current collector being established after the at least one current path between the current collector and the electrode is established.

3. The current collector of claim 1 comprising a radially asymmetric element configured for establishing at least one current path with the current collector, the at least one current path between the radially asymmetric element and the current collector being established after the current collector and the electrode are mutually positioned.

4. The current collector of claim 1 comprising at least one surface variation in the current collector configured to enhance at least one current path between the electrode and the current collector.

5. The current collector of claim 1 comprising at least one surface variation in the current collector configured to increase the number of current paths between the electrode and the current collector.

6. The current collector of claim 1 wherein the number of current paths between the electrode and the current collector is not less than 2.

7. The current collector of claim 1 comprising an area of contact between the electrode and the current collector and comprising at least one surface variation in the current collector configured to increase the area of contact between the electrode and the current collector.

8. The current collector of claim 2 comprising at least one surface variation in the current collector configured to enhance at least one current path between the current collector and the radially asymmetric element.

9. The current collector of claim 1 comprising at least one surface variation in the current collector configured to contact and deform the electrode.

10. A method comprising:
positioning a radially symmetric current collector and an electrode of a coiled energy storage device along a common radial axis, and
reducing effective electrical resistance of the coiled energy storage device by establishing at least one electrical current path between the current collector and the electrode.

11. A method comprising:
positioning a radially symmetric current collector and an electrode of a coiled energy storage device along a common radial axis, and
decreasing energy cell operating temperature by establishing at least one electrical current path between the current collector and the electrode.

12. A method comprising:
positioning a radially symmetric current collector and an electrode of a coiled energy storage device along a common radial axis, and
increasing energy cell current capacity by establishing at least one electrical current path between the current collector and the electrode.

13. An energy storage device, comprising:
a coil comprising an electrode,
a radially symmetric current collector configured for establishing at least one electrical current path with the electrode,
the coil and the current collector being positioned along a common axis, whereby at least one electrical current path between the current collector and the electrode is established irrespective of orientation of the coil and the current collector relative to the axis common to the coil and the current collector.

14. The energy storage device of claim 13 wherein the coil comprises an outer diameter and an inner diameter and the outer diameter and the inner diameter define a ratio of not less than 6 to 1.

15. The energy storage device of claim 13 comprising at least one surface variation in the current collector configured to enhance at least one current path between the electrode and the current collector.

16. The energy storage device of claim 13 comprising at least one surface variation in the current collector configured to increase the number of current paths between the electrode and the current collector.

17. The energy storage device of claim 13 wherein the number of current paths between the electrode and the current collector is not less than 2.

18. The energy storage device of claim 13 comprising an area of contact between the electrode and the current collector and comprising at least one surface variation in the current collector configured to increase the area of contact between the electrode and the current collector.

19. The energy storage device of claim 13 comprising a radially asymmetric element configured for establishing at least one current path with the current collector, the at least one current path between the radially asymmetric element and the current collector being established after the at least one current path between the current collector and the electrode is established.

20. The energy storage device of claim 19 comprising at least one surface variation in the current collector configured to enhance at least one current path between the current collector and the radially asymmetric element.

21. The energy storage device of claim 13 comprising at least one surface variation in the current collector configured to contact and deform the electrode.

22. A method of making an energy storage device, comprising:
providing a coil comprising an electrode,
providing a radially symmetric current collector configured for establishing at least one electrical current path with the electrode,
positioning the coil and the current collector along a common axis, establishing at least one electrical current path between the current collector and the electrode, whereby the at least one electrical current path between the current collector and the electrode is established irrespective of orientation of the coil and the current collector relative to the axis common to the coil and the current collector.

23. The method of claim 22 wherein the coil comprises an outer diameter and an inner diameter and the outer diameter and the inner diameter define a ratio of not less than 6 to 1.

24. The method of claim 22 comprising providing at least one surface variation in the current collector configured to enhance at least one current path between the electrode and the current collector.

25. The method of claim 22 comprising providing at least one surface variation in the current collector configured to increase the number of current paths between the electrode and the current collector.

26. The method of claim 22 wherein the step of establishing at least one electrical current path between the current collector and the electrode comprises establishing a plurality of electrical current paths between the current collector and the electrode.
The method of claim 26 wherein the number of current paths between the electrode and the current collector is not less than 2.

27. The method of claim 22 comprising providing an area of contact between the electrode and the current collector and providing at least one surface variation in the current collector configured to increase the area of contact between the electrode and the current collector.

28. The method of claim 22 comprising providing a radially asymmetric element configured for establishing at least one current path with the current collector, and establishing the at least one current path between the radially asymmetric element and the current collector after establishing the at least one current path between the current collector and the electrode.

29. The method of claim 19 comprising providing at least one surface variation in the current collector configured to enhance at least one current path between the current collector and the radially asymmetric element.

30. The method of claim 22 comprising providing at least one surface variation in the current collector configured to contact and deform the electrode.

31. A current collector comprising at least one surface variation configured for establishing at least one current path via at least one edge of an electrode of an energy storage device, the at least one current path between the current collector and the electrode being established irrespective of orientation of the electrode and the current collector relative to an axis common to the electrode and the current collector.

32. The current collector of claim 32 comprising at least one surface variation configured for establishing at least one current path with a conductive element.

33. An energy storage device, comprising: an electrode comprising at least one edge, a current collector comprising at least one surface variation configured for establishing at least one current path via the at least one edge of the electrode, the electrode and the current collector being positioned along a common axis, the at least one current path between the current collector and the electrode being established irrespective of orientation of the electrode and the current collector relative to the common axis.

34. A method of making an energy storage device, comprising: providing an electrode comprising at least one edge, providing a current collector comprising at least one surface variation configured for establishing at least one current path via the at least one edge of the electrode, positioning the electrode and the current collector along a common axis, establishing at least one electrical current path between the current collector and the electrode irrespective of orientation of the electrode and the current collector relative to the common axis.

35. A method comprising:
positioning a current collector and an electrode of an energy storage device along a common axis, and
reducing effective electrical resistance of the energy storage device by establishing at least one electrical current path between the current collector and at least one edge of the electrode.

36. A method comprising:
positioning a current collector and an electrode of an energy storage device along a common axis, and
increasing heat rejection of the energy storage device by establishing at least one electrical current path between the current collector and at least one edge of the electrode.

37. A method comprising:
positioning a current collector and an electrode of an energy storage device along a common axis, and
decreasing operating temperature of the energy storage device by establishing at least one electrical current path between the current collector and at least one edge of the electrode.

38. A method comprising:
positioning a current collector and an electrode of an energy storage device along a common axis, and
increasing current capacity of the energy storage device by establishing at least one electrical current path between the current collector and at least one edge of the electrode.

39. A method comprising:
positioning a current collector and an electrode of an energy storage device along a common axis, and
increasing efficiency of the energy storage device by establishing at least one electrical current path between the current collector and at least one edge of the electrode.

40. A method comprising:
positioning a current collector and an electrode of an energy storage device along a common axis, and
extending longevity of the energy storage device by establishing at least one electrical current path between the current collector and at least one edge of the electrode.

41. A method, comprising:
providing a current collector, the current collector configured for establishing at least one current path with an electrode of an energy storage device, the energy storage device comprising at least a pair of electrodes having at least one separator therebetween, the current collector comprising a radially symmetric configuration, whereby at least one current path between the current collector and the electrode is established irrespective of orientation of the coil and the current collector relative to an axis common to the coil and the current collector, and charging the energy storage device.

42. A method, comprising:
providing a current collector comprising at least one surface variation configured for establishing at least one current path via at least one edge of an electrode of an energy storage device, the at least one current path between the current collector and the electrode being established irrespective of orientation of the electrode and the current collector relative to an axis common to the electrode and the current collector, and
charging the energy storage device.

43. A method, comprising:
providing a current collector, the current collector configured for establishing at least one current path with an electrode of an energy storage device, the energy storage device comprising at least a pair of electrodes having at least one separator therebetween, the current collector comprising a radially symmetric configuration, whereby at least one current path between the current collector and the electrode is established irrespective of orientation of the coil and the current collector relative to an axis common to the coil and the current collector, and discharging the energy storage device.

44. A method, comprising:
providing a current collector comprising at least one surface variation configured for establishing at least one current path via at least one edge of an electrode of an energy storage device, the at least one current path between the current collector and the electrode being established irrespective of orientation of the electrode and the current collector relative to an axis common to the electrode and the current collector, and discharging the energy storage device.

45. A method, comprising:
providing a current collector comprising at least one surface variation configured for establishing at least one current path via at least one edge of an electrode of an energy storage device, the at least one current path between the current collector and the electrode being established irrespective of orientation of the electrode and the current collector relative to an axis common to the electrode and the current collector, and discharging the energy storage device, and
charging the energy storage device.

46. A method, comprising:
providing a current collector comprising at least one surface variation configured for establishing at least one current path via at least one edge of an electrode of an energy storage device, the at least one current path between the current collector and the electrode being established irrespective of orientation of the electrode and the current collector relative to an axis common to the electrode and the current collector, and discharging the energy storage device, and
discharging the energy storage device.
